(19) United States
(12) Patent Application Publication
(10) Pub. No.: US 2026/0303200 A1
(43) Pub. Date: Oct. 1, 2026

(54) INTERFERENCE MITIGATION BASED ON SATELLITE LOCATION

(71) Applicant: QUALCOMM Incorporated, San Diego, CA (US)

(72) Inventors: Marco PAPALEO, Bologna (IT); Edward George TIEDEMANN, Jr., Concord, MA (US); Lu GAO, Beijing (CN)

(21) Appl. No.: 19/478,007

(22) PCT Filed: Jul. 6, 2023
(86) PCT No.: PCT/CN2023/106030

§ 371 Date: Oct. 23, 2025

(51) Int. Cl. H04B 7/185; H04B 15/02

(52) U.S. Cl. CPC H04B 7/18513; H04B 15/02

(57) ABSTRACT

Various aspects of the present disclosure generally relate to wireless communication. In some aspects, a wireless communication device may obtain an indication of a location of a satellite. The wireless communication device may mitigate, based at least in part on the location of the satellite relative to the wireless communication device, interference with radiation propagating to or from the satellite. Numerous other aspects are described.

### FIELD OF THE DISCLOSURE

Aspects of the present disclosure generally relate to wireless communication and to techniques and apparatuses for interference mitigation based on satellite location.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a wireless communication device for wireless communication. The wireless communication device may include one or more memories and one or more processors coupled to the one or more memories. The one or more processors may be configured to obtain an indication of a location of a satellite. The one or more processors may be configured to mitigate, based at least in part on the location of the satellite relative to the wireless communication device, interference with radiation propagating to or from the satellite.

Some aspects described herein relate to a method of wireless communication performed by a wireless communication device. The method may include obtaining an indication of a location of a satellite. The method may include mitigating, based at least in part on the location of the satellite relative to the wireless communication device, interference with radiation propagating to or from the satellite.

Some aspects described herein relate to a non-transitory computer-readable medium that stores a set of instructions for wireless communication by a wireless communication device. The set of instructions, when executed by one or more processors of the wireless communication device, may cause the wireless communication device to obtain an indication of a location of a satellite. The set of instructions, when executed by one or more processors of the wireless communication device, may cause the wireless communication device to mitigate, based at least in part on the location of the satellite relative to the wireless communication device, interference with radiation propagating to or from the satellite.

Some aspects described herein relate to an apparatus for wireless communication. The apparatus may include means for obtaining an indication of a location of a satellite. The apparatus may include means for mitigating, based at least in part on the location of the satellite relative to the apparatus, interference with radiation propagating to or from the satellite.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A and 4B are diagrams illustrating examples of an environment involving satellite communications, in accordance with the present disclosure.

FIG. 5 is a diagram illustrating an example associated with interference mitigation based on satellite location, in accordance with the present disclosure.

FIG. 6 is a diagram illustrating an example process performed, for example, by a wireless communication device, in accordance with the present disclosure.

FIG. 7 is a diagram of an example apparatus for wireless communication, in accordance with the present disclosure.

### DETAILED DESCRIPTION

6G applications may be allocated frequency ranges, such as spectrum within the 7-15 GHz range, that are also used by satellite services. Assigning the spectrum for 6G applications to frequencies shared with or adjacent to satellite bands can lead to cross-interference between a terrestrial 6G network and a satellite (e.g., a space station). For example, in the case of adjacent bands, emissions from the terrestrial network can leak into the satellite band and interfere with transmissions to or from the satellite. The cumulative interference due to the deployment of the terrestrial network under the satellite footprint can cause performance degradation of the satellite service.

Various aspects relate generally to wireless communication. Some aspects more specifically relate to interference mitigation for satellite services. In some examples, a wireless communication device (e.g., a terrestrial network node, a user equipment (UE), or the like) may obtain an indication of a location of a satellite. The wireless communication device may mitigate, based at least in part on the location of the satellite relative to the wireless communication device, interference with radiation propagating to or from the satellite. For example, the wireless communication device may cease transmissions in a frequency range, reduce a transmit power for transmissions in a frequency range, or reduce radiation that is output from the wireless communication device within a configured range of angles (e.g., angles above a horizon angle).

Particular aspects of the subject matter described in this disclosure can be implemented to realize one or more of the following potential advantages. In some examples, by mitigating interference with the radiation propagating to or from the satellite based at least in part on the location of the satellite relative to the wireless communication device, the described techniques can be used to enable dynamic spectrum sharing among terrestrial and space applications with improved spectrum usage efficiency. By mitigating the interference, the wireless communication device may protect one or more services offered by the satellite. Thus, the terrestrial network and the satellite may coexist with transmissions in the same spectrum by mitigating interference due to the wireless communication device.

Ceasing transmissions in a frequency range may help to prevent transmissions from the wireless communication device in a frequency range that can interfere with the radiation propagating to or from the satellite. Additionally, or alternatively, ceasing transmissions in a frequency range may increase the actual guard-band between 6G transmissions and satellite transmissions, thereby reducing the amount of unwanted emissions seeping into the satellite (e.g., satellite receiver) bandwidth.

Reducing the transmit power for transmissions in a frequency range may help to mitigate interference with the radiation propagating to or from the satellite in the case of partially overlapping frequencies while enabling the wireless communication device to continue to output transmissions in the frequency range.

Reducing the radiation that is output from the wireless communication device within the configured range of angles may enable the wireless communication device to control the directionality of the radiation, thereby mitigating the interference while enabling the wireless communication device to continue to output transmissions outside the configured range of angles. For example, reducing the radiation that is output from the wireless communication device within angles above the horizon angle may reduce interference with radiation propagating to the satellite, which may be located above the horizon angle.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

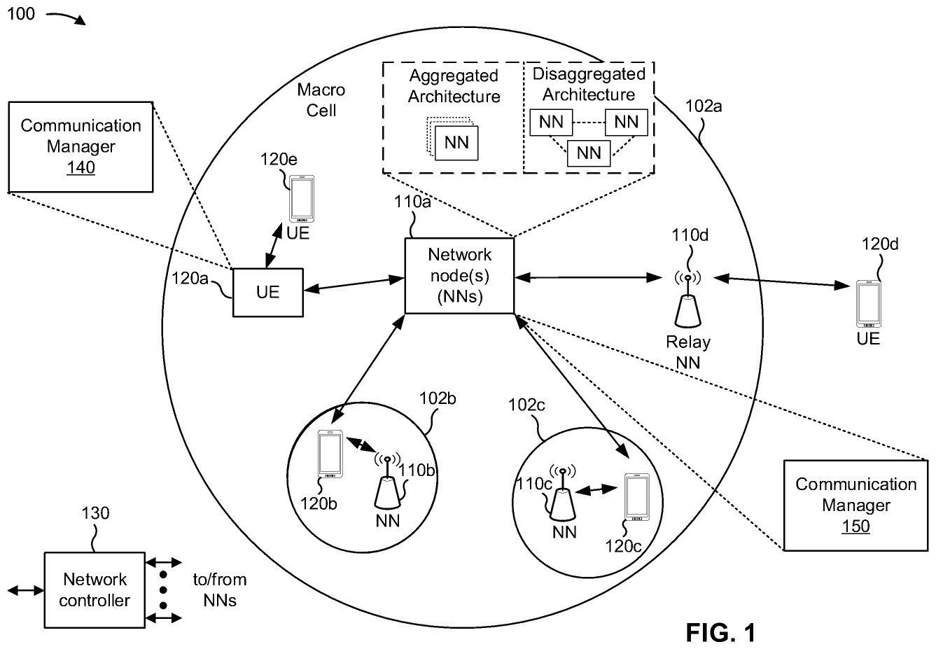

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the wireless communication device (e.g., network node 110, UE 120, or the like) may include a communication manager 140 or a communication manager 150. As described in more detail elsewhere herein, the communication manager 140 or the communication manager 150 may obtain an indication of a location of a satellite; and mitigate, based at least in part on the location of the satellite relative to the wireless communication device, interference with radiation propagating to or from the satellite. Additionally, or alternatively, the communication manager 140 or the communication manager 150 may perform one or more other operations described herein.

As indicated above, FIG. 1 is provided as an example. Other examples may differ from what is described with regard to FIG. 1.

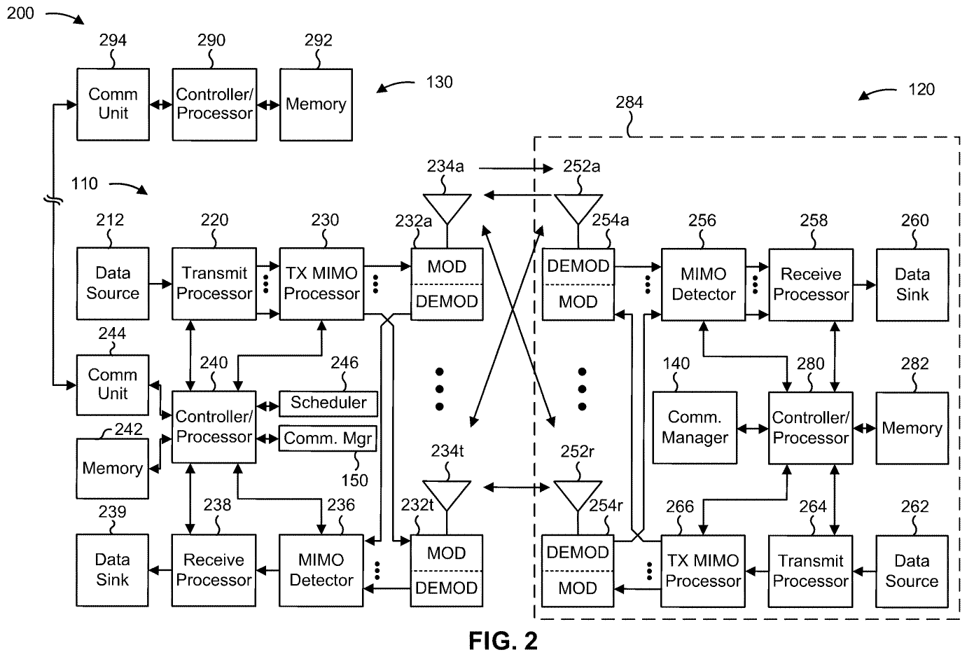

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

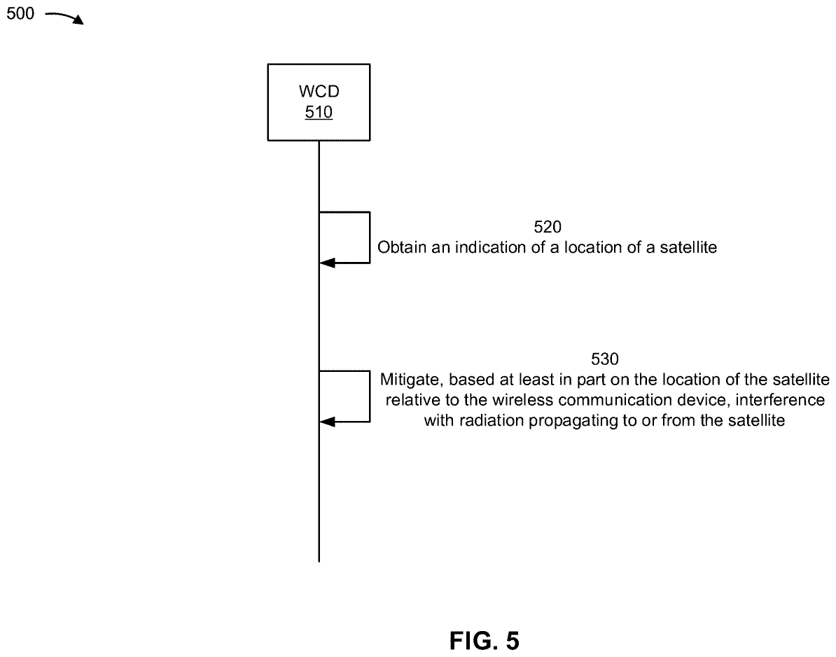

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-7).

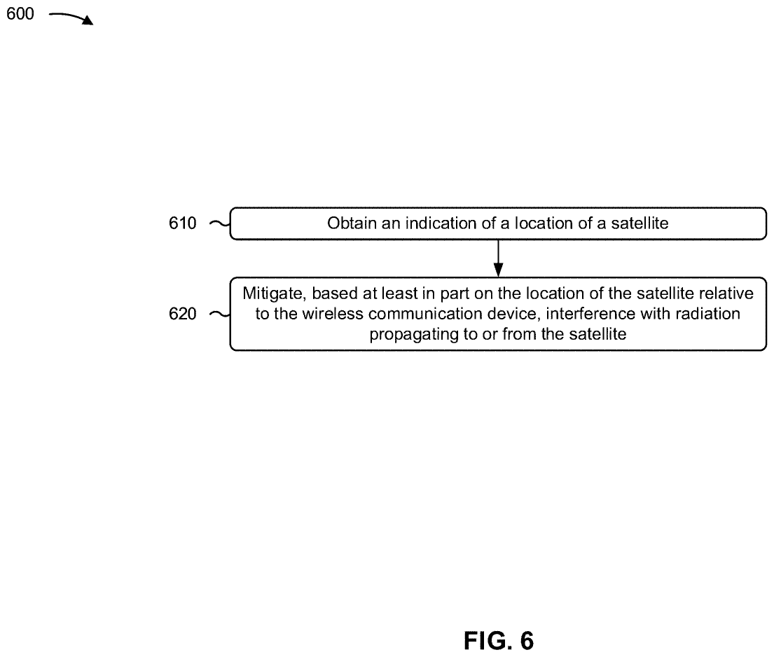

The controller/processor 240 of the network node 110, the controller/processor 280 of the UE 120, and/or any other component(s) of FIG. 2 may perform one or more techniques associated with interference mitigation based on satellite location, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6 and/or other processes as described herein. In some examples, executing instructions may include running the instructions, converting the instructions, compiling the instructions, and/or interpreting the instructions, among other examples. In some aspects, the wireless communication device described herein is the network node 110, is included in the network node 110, or includes one or more components of the network node 110 shown in FIG. 2. In some aspects, the wireless communication device described herein is the UE 120, is included in the UE 120, or includes one or more components of the UE 120 shown in FIG. 2.

In some aspects, a wireless communication device (e.g., the UE 120) includes means for obtaining an indication of a location of a satellite; and/or means for mitigating, based at least in part on the location of the satellite relative to the wireless communication device, interference with radiation propagating to or from the satellite. In some aspects, the means for the wireless communication device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the wireless communication device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

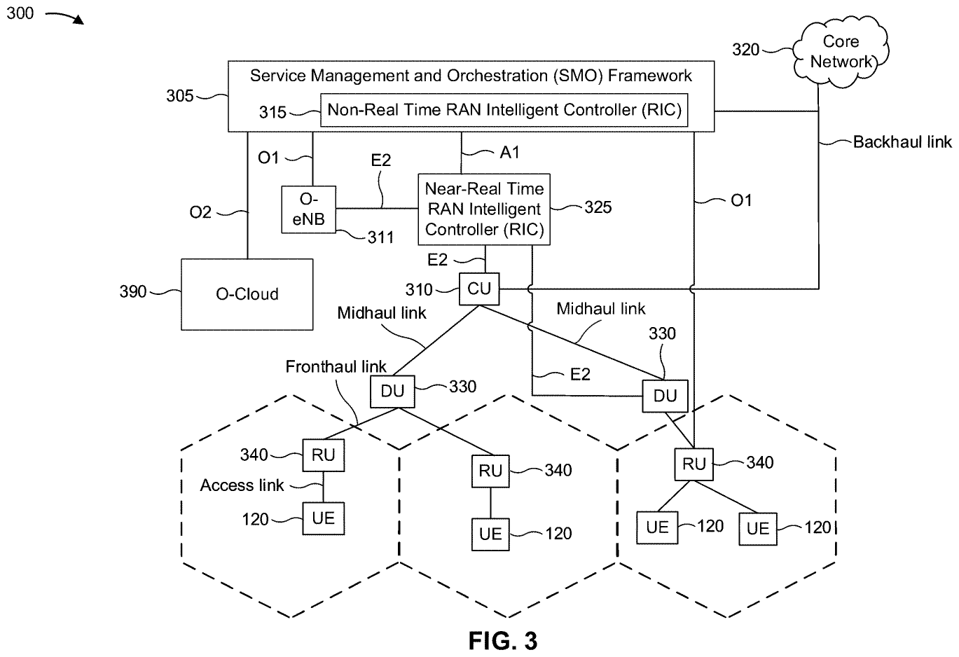

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

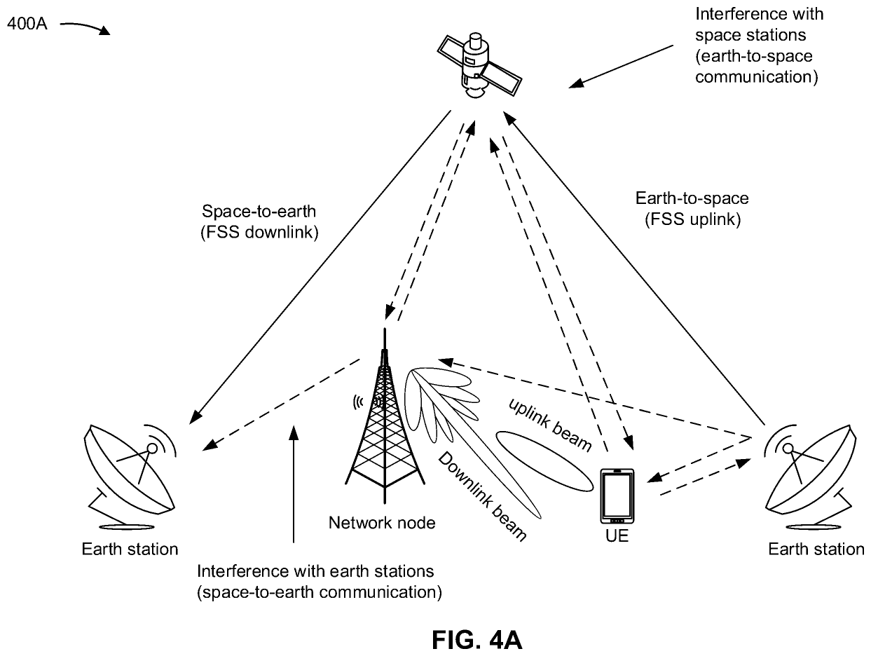

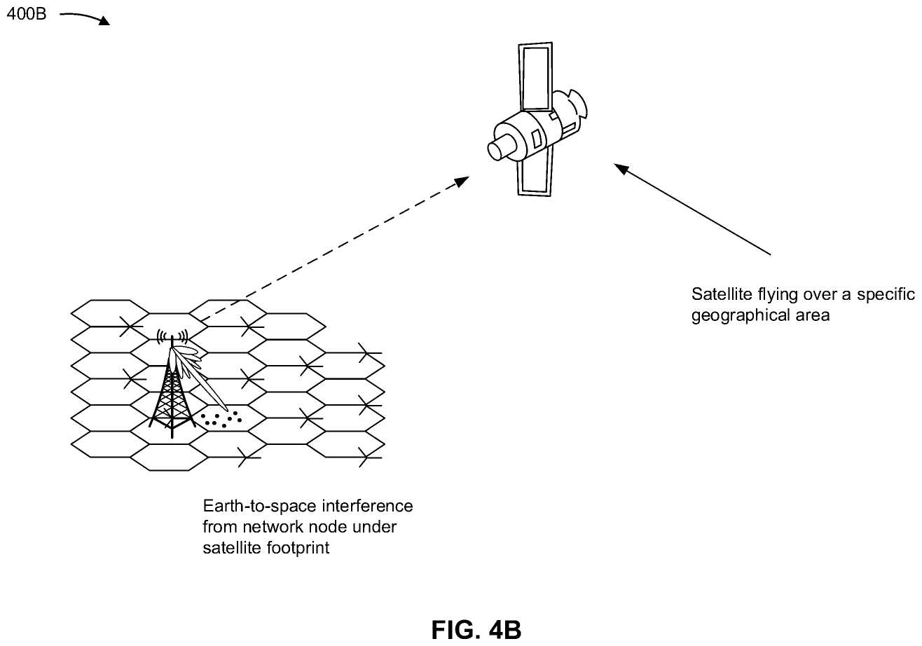

FIGS. 4A and 4B are diagrams illustrating examples 400A and 400B of an environment involving satellite communications, in accordance with the present disclosure.

In example 400A, the satellite may be an fixed satellite service (FSS) satellite that provides telecommunication services (e.g., exchanging packets with a UE). In some examples, the FSS satellite may be configured for earth-to-space communication and/or space-to-earth communication. Earth-to-space communication may include uplink transmissions from a terrestrial network (e.g., including UEs, network nodes, earth stations, or the like) to the satellite. Space-to-earth communication may include downlink transmissions from the satellite to a terrestrial network (e.g., including UEs, network nodes, earth stations, or the like).

In example 400B, the satellite may be an FSS satellite or an earth exploration satellite service (EESS) satellite. An EESS satellite may provide radar-like passive sensing services. For example, the EESS satellite may transmit an incident electromagnetic wave and detect a reflected electromagnetic wave to obtain measurement data.

6G applications may be allocated frequency ranges, such as spectrum within the 7-15 GHz range, that are also used by satellite services (e.g., FSS, EESS, or the like). As a result, 6G deployments may share spectrum with satellite services.

Assigning the spectrum for 6G applications to frequencies shared with (e.g., co-channel operation) or adjacent to (e.g., non-co-channel operation) satellite bands can lead to cross-interference between the terrestrial network and the satellite. For example, because 6G systems operating in the mid-band or high-band can adopt active antenna systems (AAS), the sidelobe of the antenna pattern can create severe performance degradation. For example, in the case of non-co-channel operation, emissions from the terrestrial network can leak into the satellite band and thereby interfere with transmissions to or from the satellite.

For frequency bands shared with or adjacent to the spectrum used for FSS in uplink (e.g., earth-to-space) communications or EESS, the cumulative interference due to the deployment of the terrestrial network under the satellite footprint can cause performance degradation. As shown in examples 400A and 400B, radiation originating from the terrestrial network (e.g., from UEs and/or network nodes) can interfere with signals (e.g., earth-to-space communications, measurement data, or the like) received by the satellite. For instance, radiation from network nodes and/or UEs may reach the satellite and cumulatively interfere with the signals received by the satellite. As shown in example 400A, transmissions originating from the terrestrial network (e.g., from UEs and/or network nodes) can also/alternatively interfere with signals (e.g., space-to-earth communications) sent from the satellite and received by earth stations.

As indicated above, FIGS. 4A and 4B are provided as examples. Other examples may differ from what is described with respect to FIGS. 4A and 4B.

FIG. 5 is a diagram illustrating an example 500 associated with interference mitigation based on satellite location, in accordance with the present disclosure. As shown in FIG. 5, a wireless communication device (“WCD”) 510 may perform one or more operations to mitigate the interference based on the location of a satellite. The wireless communication device 510 may be the network node 110 (e.g., a terrestrial network node), the UE 120, or the like).

As shown by reference number 520, the wireless communication device 510 may obtain an indication of a location of a satellite. For example, the wireless communication device 510 may detect or determine an orbit (e.g., a trajectory) of the satellite. The orbit may be a non-geo-stationary orbit (NGSO). The location of the satellite may be based on the orbit of the satellite.

The wireless communication device 510 may obtain the indication of the location of the satellite based at least in part on predetermined (e.g., a priori) information regarding the location of the satellite. In some examples, the predetermined information may be stored in a database. In some examples, the wireless communication device 510 may obtain the predetermined information from a standards document (e.g., an international telecommunication union (ITU) filing that contains a database, such as an ITU radiocommunications (ITU-R) database).

The predetermined information may relate to the orbit of the satellite, and the wireless communication device 510 may determine the location of the satellite based on the predetermined information and/or other information, such as timing information (e.g., date and time), the location of the wireless communication device 510, or the like. The predetermined information may be stored locally (e.g., on the wireless communication device 510) or remotely (e.g., on a server). Obtaining the indication of the location of the satellite based at least in part on the predetermined information may enable the wireless communication device 510 to determine the location of the satellite without introducing additional hardware to the network infrastructure.

In some examples, the wireless communication device 510 may obtain one or more indications of the location of the satellite from one or more satellite detectors. For example, the satellite detectors may be ad hoc satellite RF detectors (e.g., a receiver platform including one or more receivers). The satellite detector(s) may obtain transmissions from the satellite (e.g., downlink communications, incident electromagnetic waves for measurements, or the like), which may provide the indication(s) of the location of the satellite. For example, the satellite detector(s) may obtain the transmissions from the satellite over a period of time, which may provide an indication of the orbit of the satellite.

In some examples, at least one of the satellite detectors may be co-located with the wireless communication device 510 (e.g., a satellite detector may be located at a site of network node 110). In some examples, at least one of the satellite detectors may not be co-located with the wireless communication device 510 (e.g., a satellite detector may be located at a location outside a site of network node 110). Not co-locating a satellite detector with the wireless communication device 510 may enable the satellite detector to be placed at a location that increases the probability of detection, such as a location that has an improved line of sight to the satellite.

In some examples, a plurality of satellite detectors may obtain transmissions from the satellite. The plurality of satellite detectors may provide a plurality of indications of the location of the satellite, which may refine or improve the accuracy of the location of the satellite compared to the location of the satellite determined based on measurements from a single satellite detector.

The wireless communication device 510 may obtain the indication(s) of the location of the satellite from one or more satellite detector(s) directly or via one or more intermediary devices. The satellite detector(s), intermediary device(s), and/or wireless communication device 510 may compute the location of the satellite based on one or more raw measurements of one or more satellite transmissions detected by the satellite detector(s). Thus, the indication(s) of the location of the satellite obtained by the wireless communication device 510 may comprise the raw measurements (in which case the wireless communication device 510 may determine the location of the satellite based on the raw measurements), an indication of the orbit of the satellite that has been determined by a satellite detector or an intermediary device based on the raw measurements, or the like. For example, the satellite detector may infer the orbit of the satellite and communicate the orbit of the satellite to the 6G network, which may include the wireless communication device 510 and/or intermediary device(s).

As shown by reference number 530, the wireless communication device 510 may mitigate, based at least in part on the location of the satellite relative to the wireless communication device 510, interference with radiation propagating to or from the satellite. For example, the wireless communication device 510 may apply one or more interference mitigation techniques based on the terrestrial (e.g., 6G) network determining that the satellite is located above a geographical area (e.g., country, region, or the like) that encompasses the wireless communication device 510. For example, the wireless communication device 510 may apply the interference mitigation technique(s) when the presence of the satellite near (e.g., within a threshold distance from) the geographical area is detected, and may cease applying the interference mitigation technique(s) when the satellite is no longer near the geographical area.

In some examples, the wireless communication device 510 may mitigate interference with radiation propagating to the satellite, such as earth-to-space (e.g., uplink) communications, reflected electromagnetic waves for measurement by the satellite, or the like. In some examples, the wireless communication device 510 may mitigate interference with radiation propagating from the satellite to an earth station, such as space-to-earth (e.g., downlink) communications.

Mitigating the interference with the radiation propagating to or from the satellite based at least in part on the location of the satellite relative to the wireless communication device 510 may enable dynamic spectrum sharing among terrestrial and space applications with improved spectrum usage efficiency. By mitigating the interference, the wireless communication device 510 may protect the service(s) offered by the satellite. Thus, a terrestrial network and satellite (e.g., satellite receiver) may coexist with transmissions in the same spectrum by mitigating interference due to an aggressor node (e.g., the wireless communication device 510) in the terrestrial network.

By mitigating the interference based at least in part on the location of the satellite relative to the wireless communication device 510, the wireless communication device 510 may mitigate the interference during specific amounts of time that the satellite flies over a geographical area (e.g., in cases of sparse satellite coverage for the geographical area), which may reduce the impact of the interference mitigation on the performance of the terrestrial network. For example, the wireless communication device 510 may perform the interference mitigation during limited amounts of time during a day, week, or the like, which may reduce the impact of the interference mitigation on the performance of the wireless communication device 510. For example, the wireless communication device 510 may detect or determine when the satellite is within a range of transmissions of the wireless communication device 510 and, in response, perform opportunistic interference mitigation.

For example, mitigating interference with radiation propagating to the satellite may protect EESS and/or uplink FSS by reducing the amount of cumulative interference from terrestrial deployments with the satellite receiver. For example, if the satellite provides earth-to-space communications, then the wireless communication device 510 may protect the satellite receiver from interference due to emissions from the wireless communication device 510.

Additionally, or alternatively, mitigating interference with radiation propagating from the satellite to an earth station may protect downlink FSS by reducing the amount of cumulative interference from terrestrial deployments with the earth station. For example, if the satellite provides space-to-earth communications, then the wireless communication device 510 may protect the earth station from interference due to emissions from the wireless communication device 510.

In some examples, the wireless communication device 510 may belong to a set of wireless communication devices. The set of wireless communication devices may include network nodes, UEs, and/or the like and may belong to a terrestrial 6G network. In some examples, the set of wireless communication devices may be a set of network nodes referred to as a “base station interference set.” The set of wireless communication devices may include wireless communication devices that are local to the satellite (e.g., within the geographical area of the satellite) and, as a result, could interfere with the satellite.

The set of wireless communication devices may be identified based on the indication of the location of the satellite (e.g., based on information relating to the satellite orbit). For example, the set of wireless communication devices may include wireless communication devices that would, without the mitigation techniques described herein, contribute more heavily to the interference with the radiation propagating to or from the satellite. The set of wireless communication devices may be identified by any suitable device in, or connected to, the terrestrial 6G network.

The wireless communication device 510 may mitigate the interference in conjunction with the set of wireless communication devices. For example, at least a portion of the wireless communication devices in the set of wireless communication devices may implement one or more interference mitigation techniques. Mitigating the interference in conjunction with the set of wireless communication devices may reduce interference that is cumulatively caused by the set of wireless communication devices.

In some examples, the set of wireless communication devices may be dynamically updated based at least in part on the location of the satellite. For example, as the satellite changes locations within the satellite orbit, the set of wireless communication devices may be updated to exclude wireless communication devices that the geographical area under the satellite no longer includes, and include wireless communication devices that the geographical area under the satellite includes. The set of wireless communication devices may be dynamically updated by any suitable device in, or connected to, the terrestrial 6G network. The set of wireless communication devices being dynamically updated may help to ensure that the satellite is protected from interference while enabling wireless communication devices that are unlikely to interfere with the satellite to cease implementing the inference mitigation techniques.

The wireless communication device 510 may mitigate the interference with the radiation propagating to or from the satellite using any suitable interference mitigation technique(s). Examples of suitable interference mitigation techniques may include ceasing transmissions, reducing transmit power, beamforming (e.g., beam nulling), or the like. The wireless communication device 510 may dynamically adjust a given interference mitigation technique (e.g., by resuming transmissions, adjusting the transmit power level, adjusting a beamforming configuration, or the like) based on changes in the location of the satellite. Additionally, or alternatively, the wireless communication device 510 may dynamically switch between interference mitigation techniques based on changes in the location of the satellite.

In some examples, the terrestrial network (e.g., wireless communication device 510) may determine which interference mitigation technique to use based on whether the wireless communication device 510 and satellite implement co-channel operation or non-co-channel (e.g., frequency-adjacent) operation. In co-channel operation, the wireless communication device 510 and the satellite are both operable to communicate via the same channel. Co-channel operation can involve partially overlapping frequencies (e.g., where the operating frequency of wireless communication device 510 partially overlaps with the operating frequency of the satellite) or fully overlapping frequencies (e.g., where the operating frequency of wireless communication device 510 fully overlaps with the operating frequency of the satellite).

In the case of partially overlapping frequencies, the wireless communication device 510 is operable to communicate via a first frequency range of the channel, and the satellite is operable to communicate via a second frequency range of the channel. The first frequency range (e.g., the entire transmission bandwidth of the wireless communication device 510) partially overlaps with the second frequency range in a third frequency range. For example, the third frequency range may be a portion of the first frequency range that overlaps with the second frequency range. Because the first frequency range overlaps with the second frequency range partially, another portion of the first frequency range may not overlap with the second frequency.

In some examples involving partially overlapping frequencies, the wireless communication device 510 may cease transmissions in the third frequency range or cease transmissions in the first frequency range. For example, the wireless communication device 510 may avoid transmissions in one or more frequencies overlapping with satellite transmissions (e.g., the third frequency range) or may avoid transmissions in the entire transmission bandwidth (e.g., the first frequency range). Ceasing transmissions in the third frequency range or ceasing transmissions in the first frequency range may help to prevent transmissions from the wireless communication device 510 in a frequency range that can interfere with the radiation propagating to or from the satellite in the case of partially overlapping frequencies.

In some examples involving partially overlapping frequencies, the wireless communication device 510 may reduce a transmit power for transmissions in the third frequency range or reduce a transmit power for transmissions in the first frequency range. For example, the wireless communication device 510 may reduce the loading for one or more frequencies overlapping with satellite transmissions (e.g., the third frequency range) or reduce the loading for the entire transmission bandwidth (e.g., the first frequency range). Reducing the transmit power for transmissions in the third frequency range or reducing the transmit power for transmissions in the first frequency range may help to mitigate interference with the radiation propagating to or from the satellite in the case of partially overlapping frequencies while enabling the wireless communication device 510 to continue to output transmissions.

In the case of fully overlapping frequencies, the wireless communication device 510 is operable to communicate via a first frequency range of the channel, and the satellite is operable to communicate via a second frequency range of the channel. The first frequency range (e.g., the entire transmission bandwidth of the wireless communication device 510) fully overlaps with the second frequency range. For example, the entire transmission bandwidth of the wireless communication device 510 may be included within the second frequency range.

In some examples involving fully overlapping frequencies, the wireless communication device 510 may cease transmissions in the first frequency range. For example, the wireless communication device 510 may avoid transmissions in one or more frequencies overlapping with satellite transmissions (e.g., the third frequency range). Ceasing transmissions in the first frequency range may help to prevent transmissions from the wireless communication device 510 in a frequency range that can interfere with the radiation propagating to or from the satellite in the case of fully overlapping frequencies.

In some examples involving fully overlapping frequencies, the wireless communication device 510 may reduce a transmit power for transmissions in the first frequency range. For example, the wireless communication device 510 may reduce the loading in the entire transmission bandwidth (e.g., the first frequency range). Reducing the transmit power for transmissions in the first frequency range may help to mitigate interference with the radiation propagating to or from the satellite in the case of fully overlapping frequencies while enabling the wireless communication device 510 to continue to output transmissions.

In non-co-channel operation, the wireless communication device 510 is operable to communicate via a first channel, and the satellite is operable to communicate via a second channel. For example, the wireless communication device 510 and the satellite may be operable to communicate via different channels.

In some examples involving non-co-channel operation, the wireless communication device 510 may cease transmissions in a frequency range of the first channel. For example, the wireless communication device 510 may avoid transmissions in all or part of the transmission bandwidth of the wireless communication device 510. Ceasing transmissions in the frequency range of the first channel may increase the actual guard-band between 6G transmissions and satellite transmissions, thereby reducing the amount of unwanted emissions seeping into the satellite (e.g., satellite receiver) bandwidth.

In some examples involving co-channel operation (e.g., partially or fully overlapping frequencies) or non-co-channel operation, the wireless communication device 510 may reduce radiation that is output from the wireless communication device 510 within a configured range of angles. The radiation may be a byproduct of beamformed transmissions output by the wireless communication device 510. The wireless communication device 510 may reduce radiation that is output in a direction of the satellite and/or one or more earth stations.

The wireless communication device 510 may reduce the radiation in specific angles or directions using beamforming techniques. For instance, because adjacent channels may be associated with similar beam patterns, in the example of non-co-channel operation, the wireless communication device 510 may perform the beamforming based on the expected beam shape for the bandwidth of the satellite receiver. Reducing the radiation that is output from the wireless communication device 510 within the configured range of angles may enable the wireless communication device 510 to control the directionality of the radiation, thereby mitigating the interference while enabling the wireless communication device 510 to continue to output transmissions.

The wireless communication device 510 may reduce radiation that is output from the wireless communication device 510 within a configured range of angles that includes angles above a horizon angle. For example, the wireless communication device 510 may reduce the radiation output at angles above the horizon angle. The horizon angle may be zero degrees (or within a threshold angle of zero degrees) relative to the surface of the earth at the location of the wireless communication device 510. Reducing the radiation that is output from the wireless communication device 510 within the configured range of angles that includes the horizon angle may reduce interference with radiation propagating to the satellite, which may be located above the horizon angle.

As indicated above, FIG. 5 is provided as an example. Other examples may differ from what is described with respect to FIG. 5.

FIG. 6 is a diagram illustrating an example process 600 performed, for example, by a wireless communication device, in accordance with the present disclosure. Example process 600 is an example where the wireless communication device (e.g., wireless communication device 510) performs operations associated with interference mitigation based on satellite location.

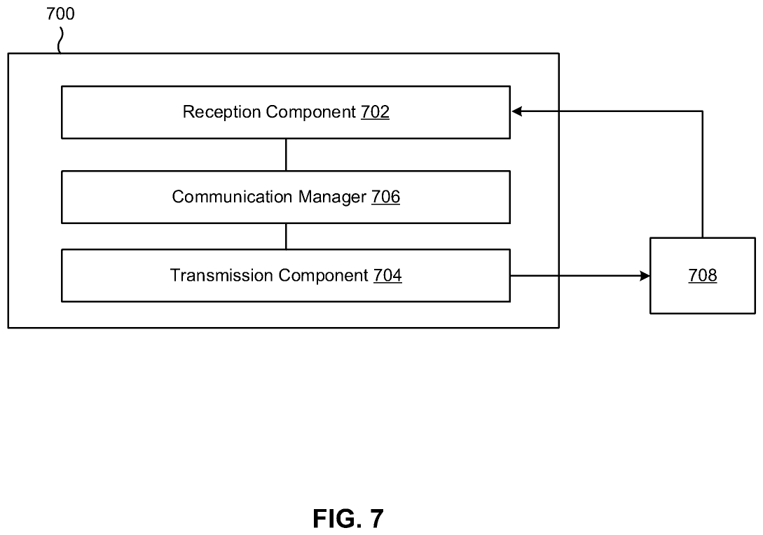

As shown in FIG. 6, in some aspects, process 600 may include obtaining an indication of a location of a satellite (block 610). For example, the wireless communication device (e.g., using reception component 702 and/or communication manager 706, depicted in FIG. 7) may obtain an indication of a location of a satellite, as described above in connection with FIG. 5. In a first aspect, obtaining the indication of the location of the satellite includes obtaining the indication of the location of the satellite based at least in part on predetermined information regarding the location of the satellite. In a second aspect, the predetermined information is stored in a database. In a third aspect, obtaining the indication of the location of the satellite includes obtaining, from one or more satellite detectors, one or more indications of the location of the satellite.

As further shown in FIG. 6, in some aspects, process 600 may include mitigating, based at least in part on the location of the satellite relative to the wireless communication device, interference with radiation propagating to or from the satellite (block 620). For example, the wireless communication device (e.g., using communication manager 706, depicted in FIG. 7) may mitigate, based at least in part on the location of the satellite relative to the wireless communication device, interference with radiation propagating to or from the satellite, as described above in connection with FIG. 5. In a fourth aspect, mitigating the interference with the radiation propagating to or from the satellite includes mitigating the interference with the radiation propagating to the satellite. In a fifth aspect, mitigating the interference with the radiation propagating to or from the satellite includes mitigating the interference with the radiation propagating from the satellite to an earth station.

Process 600 may include additional aspects, such as any single aspect or any combination of aspects described above or below and/or in connection with one or more other processes described elsewhere herein.

In a sixth aspect, the wireless communication device is a terrestrial network node.

In a seventh aspect, the wireless communication device is a UE.

In an eighth aspect, the wireless communication device belongs to a set of wireless communication devices, and mitigating the interference with the radiation propagating to or from the satellite includes mitigating the interference in conjunction with the set of wireless communication devices.

In a ninth aspect, the set of wireless communication devices is dynamically updated based at least in part on the location of the satellite.

In a tenth aspect, the wireless communication device is operable to communicate via a channel, and the satellite is operable to communicate via the channel.

In an eleventh aspect, the wireless communication device is operable to communicate via a first frequency range of the channel, the satellite is operable to communicate via a second frequency range of the channel, and the first frequency range partially overlaps with the second frequency range in a third frequency range.

In a twelfth aspect, mitigating the interference with the radiation propagating to or from the satellite includes ceasing transmissions in the third frequency range or ceasing transmissions in the first frequency range.

In a thirteenth aspect, mitigating the interference with the radiation propagating to or from the satellite includes reducing a transmit power for transmissions in the third frequency range or reducing a transmit power for transmissions in the first frequency range.

In a fourteenth aspect, the wireless communication device is operable to communicate via a first frequency range of the channel, the satellite is operable to communicate via a second frequency range of the channel, and the first frequency range fully overlaps with the second frequency range.

In a fifteenth aspect, mitigating the interference with the radiation propagating to or from the satellite includes ceasing transmissions in the first frequency range.

In a sixteenth aspect, mitigating the interference with the radiation propagating to or from the satellite includes reducing a transmit power for transmissions in the first frequency range.

In a seventeenth aspect, the wireless communication device is operable to communicate via a first channel, and the satellite is operable to communicate via a second channel.

In an eighteenth aspect, mitigating the interference with the radiation propagating to or from the satellite includes ceasing transmissions in a frequency range of the first channel.

In a nineteenth aspect, mitigating the interference with the radiation propagating to or from the satellite includes reducing radiation that is output from the wireless communication device within a configured range of angles.

In a twentieth aspect, the configured range of angles includes angles above a horizon angle.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a wireless communication device, or a wireless communication device may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 or the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIG. 5. Additionally, or alternatively, the apparatus 700 may be configured to perform one or more processes described herein, such as process 600 of FIG. 6. In some aspects, the apparatus 700 and/or one or more components shown in FIG. 7 may include one or more components of the wireless communication device described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the wireless communication device described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, a modem, a modulator, a transmit MIMO processor, a transmit processor, a controller/processor, a memory, or a combination thereof, of the wireless communication device described in connection with FIG. 2. In some aspects, the transmission component 704 may be co-located with the reception component 702 in a transceiver.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may obtain an indication of a location of a satellite. The communication manager 706 may mitigate, based at least in part on the location of the satellite relative to the wireless communication device, interference with radiation propagating to or from the satellite.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a wireless communication device, comprising: obtaining an indication of a location of a satellite; and mitigating, based at least in part on the location of the satellite relative to the wireless communication device, interference with radiation propagating to or from the satellite.

Aspect 2: The method of Aspect 1, wherein the wireless communication device is a terrestrial network node.

Aspect 3: The method of any of Aspects 1-2, wherein the wireless communication device is a user equipment.

Aspect 4: The method of any of Aspects 1-3, wherein mitigating the interference with the radiation propagating to or from the satellite includes: mitigating the interference with the radiation propagating to the satellite.

Aspect 5: The method of any of Aspects 1-4, wherein mitigating the interference with the radiation propagating to or from the satellite includes: mitigating the interference with the radiation propagating from the satellite to an earth station.

Aspect 6: The method of any of Aspects 1-5, wherein obtaining the indication of the location of the satellite includes: obtaining the indication of the location of the satellite based at least in part on predetermined information regarding the location of the satellite.

Aspect 7: The method of Aspect 6, wherein the predetermined information is stored in a database.

Aspect 8: The method of any of Aspects 1-7, wherein obtaining the indication of the location of the satellite includes: obtaining, from one or more satellite detectors, one or more indications of the location of the satellite.

Aspect 9: The method of any of Aspects 1-8, wherein the wireless communication device belongs to a set of wireless communication devices, and wherein mitigating the interference with the radiation propagating to or from the satellite includes: mitigating the interference in conjunction with the set of wireless communication devices.

Aspect 10: The method of Aspect 9, wherein the set of wireless communication devices is dynamically updated based at least in part on the location of the satellite.

Aspect 11: The method of any of Aspects 1-10, wherein the wireless communication device is operable to communicate via a channel, and wherein the satellite is operable to communicate via the channel.

Aspect 12: The method of Aspect 11, wherein the wireless communication device is operable to communicate via a first frequency range of the channel, wherein the satellite is operable to communicate via a second frequency range of the channel, and wherein the first frequency range partially overlaps with the second frequency range in a third frequency range.

Aspect 13: The method of Aspect 12, wherein mitigating the interference with the radiation propagating to or from the satellite includes: ceasing transmissions in the third frequency range or ceasing transmissions in the first frequency range.

Aspect 14: The method of Aspect 12, wherein mitigating the interference with the radiation propagating to or from the satellite includes: reducing a transmit power for transmissions in the third frequency range or reducing a transmit power for transmissions in the first frequency range.

Aspect 15: The method of Aspect 11, wherein the wireless communication device is operable to communicate via a first frequency range of the channel, wherein the satellite is operable to communicate via a second frequency range of the channel, and wherein the first frequency range fully overlaps with the second frequency range.

Aspect 16: The method of Aspect 15, wherein mitigating the interference with the radiation propagating to or from the satellite includes: ceasing transmissions in the first frequency range.

Aspect 17: The method of Aspect 15, wherein mitigating the interference with the radiation propagating to or from the satellite includes: reducing a transmit power for transmissions in the first frequency range.

Aspect 18: The method of any of Aspects 1-17, wherein the wireless communication device is operable to communicate via a first channel, and wherein the satellite is operable to communicate via a second channel.

Aspect 19: The method of Aspect 18, wherein mitigating the interference with the radiation propagating to or from the satellite includes: ceasing transmissions in a frequency range of the first channel.

Aspect 20: The method of any of Aspects 1-19, wherein mitigating the interference with the radiation propagating to or from the satellite includes: reducing radiation that is output from the wireless communication device within a configured range of angles.

Aspect 21: The method of Aspect 20, wherein the configured range of angles includes angles above a horizon angle.

Aspect 22: An apparatus for wireless communication at a device, comprising a processor; memory coupled with the processor; and instructions stored in the memory and executable by the processor to cause the apparatus to perform the method of one or more of Aspects 1-21.

Aspect 23: A device for wireless communication, comprising a memory and one or more processors coupled to the memory, the one or more processors configured to perform the method of one or more of Aspects 1-21.

Aspect 24: An apparatus for wireless communication, comprising at least one means for performing the method of one or more of Aspects 1-21.

Aspect 25: A non-transitory computer-readable medium storing code for wireless communication, the code comprising instructions executable by a processor to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A wireless communication device for wireless communication, comprising:
one or more memories; and
one or more processors, coupled to the one or more memories, configured to:
obtain an indication of a location of a satellite; and
mitigate, based at least in part on the location of the satellite relative to the wireless communication device, interference with radiation propagating to or from the satellite.

2. (canceled)

3. (canceled)

4. The wireless communication device of claim 1, wherein the one or more processors, to mitigate the interference with the radiation propagating to or from the satellite, are configured to:
mitigate the interference with the radiation propagating to the satellite.

5. The wireless communication device of claim 1, wherein the one or more processors, to mitigate the interference with the radiation propagating to or from the satellite, are configured to:
mitigate the interference with the radiation propagating from the satellite to an earth station.

6. The wireless communication device of claim 1, wherein the one or more processors, to obtain the indication of the location of the satellite, are configured to:
obtain the indication of the location of the satellite based at least in part on predetermined information regarding the location of the satellite.

7. (canceled)

8. The wireless communication device of claim 1, wherein the one or more processors, to obtain the indication of the location of the satellite, are configured to:
obtain, from one or more satellite detectors, one or more indications of the location of the satellite.

9. The wireless communication device of claim 1, wherein the wireless communication device belongs to a set of wireless communication devices, and wherein the one or more processors, to mitigate the interference with the radiation propagating to or from the satellite, are configured to:
mitigate the interference in conjunction with the set of wireless communication devices.

10. The wireless communication device of claim 9, wherein the set of wireless communication devices is dynamically updated based at least in part on the location of the satellite.

11. The wireless communication device of claim 1, wherein the wireless communication device is operable to communicate via a channel, and wherein the satellite is operable to communicate via the channel.

12. The wireless communication device of claim 11, wherein the wireless communication device is operable to communicate via a first frequency range of the channel, wherein the satellite is operable to communicate via a second frequency range of the channel, and wherein the first frequency range partially overlaps with the second frequency range in a third frequency range.

13. The wireless communication device of claim 12, wherein the one or more processors, to mitigate the interference with the radiation propagating to or from the satellite, are configured to:
cease transmissions in the third frequency range or cease transmissions in the first frequency range.

14. The wireless communication device of claim 12, wherein the one or more processors, to mitigate the interference with the radiation propagating to or from the satellite, are configured to:
reduce a transmit power for transmissions in the third frequency range or reduce a transmit power for transmissions in the first frequency range.

15. The wireless communication device of claim 11, wherein the wireless communication device is operable to communicate via a first frequency range of the channel, wherein the satellite is operable to communicate via a second frequency range of the channel, and wherein the first frequency range fully overlaps with the second frequency range.

16. The wireless communication device of claim 15, wherein the one or more processors, to mitigate the interference with the radiation propagating to or from the satellite, are configured to:
cease transmissions in the first frequency range.

17. The wireless communication device of claim 15, wherein the one or more processors, to mitigate the interference with the radiation propagating to or from the satellite, are configured to:
reduce a transmit power for transmissions in the first frequency range.

18. The wireless communication device of claim 1, wherein the wireless communication device is operable to communicate via a first channel, and wherein the satellite is operable to communicate via a second channel.

19. The wireless communication device of claim 18, wherein the one or more processors, to mitigate the interference with the radiation propagating to or from the satellite, are configured to:
cease transmissions in a frequency range of the first channel.

20. The wireless communication device of claim 1, wherein the one or more processors, to mitigate the interference with the radiation propagating to or from the satellite, are configured to:
reduce radiation that is output from the wireless communication device within a configured range of angles.

21. The wireless communication device of claim 20, wherein the configured range of angles includes angles above a horizon angle.

22. A method of wireless communication performed by a wireless communication device, comprising:
obtaining an indication of a location of a satellite; and
mitigating, based at least in part on the location of the satellite relative to the wireless communication device, interference with radiation propagating to or from the satellite.

23. (canceled)

24. (canceled)

25. (canceled)

26. (canceled)

27. (canceled)

28. An apparatus for wireless communication, comprising:
means for obtaining an indication of a location of a satellite; and
means for mitigating, based at least in part on the location of the satellite relative to the apparatus, interference with radiation propagating to or from the satellite.

29. (canceled)

30. (canceled)
